(19) United States
(12) Patent Application Publication
(10) Pub. No.: US 2026/0170585 A1
(43) Pub. Date: Jun. 18, 2026

(54) REMEDY MANAGEMENT DEVICE

(71) Applicant: NTT DOCOMO, INC., Tokyo (JP)

(72) Inventors: Yuta TOYAMA, Chiyoda-ku (JP); Kazuhiko TAKENO, Chiyoda-ku (JP); Masaki NAKAMURA, Chiyoda-ku (JP)

(73) Assignee: NTT DOCOMO, INC., Tokyo (JP)

(21) Appl. No.: 19/103,049

(22) PCT Filed: Oct. 18, 2023
(86) PCT No.: PCT/JP2023/037750

§ 371 Date: Feb. 11, 2025

(30) Foreign Application Priority Data
Nov. 10, 2022 (JP) 2022-180370

(51) Int. Cl. G06Q 50/26; B60L 55/00; G01C 21/34; G06Q 10/0631

(52) U.S. Cl. CPC G06Q 50/265; B60L 55/00; G01C 21/3415; G06Q 10/06315

(57) ABSTRACT

Provided is an aid management server capable of efficiently aiding a facility by means of an aid vehicle. An EV data reception unit 103 receives EV data from each EV 200. An aid facility decision unit 104 acquires a storage location of an aid vehicle and the number of aid vehicles. Moreover, an aid facility information reception unit 102 receives aid facility information from each of a plurality of aid facilities 3200, and the aid facility decision unit 104 acquires the aid facility information. A power supply aid schedule decision unit 105 functions as a derivation unit for deriving an aid pattern, and derives, on the basis of the location of an aid facility 300, an aid pattern that indicates a movement route for the EV 200 as the aid vehicle to aid the aid facility 300. A power supply aid schedule transmission unit 106 transmits the aid pattern to a driver of the EV 200.

### TECHNICAL FIELD

The present invention relates to an aid management device for performing power supply aid for an aid facility.

### BACKGROUND ART

Electric vehicles (EVs) are generally perceived as ordinary vehicles. However, in recent years, EVs have been increasingly expected to serve as disaster countermeasures by functioning as distributed power supplies.

The primary use of the EVs involves backing up power by driving the EVs to a facility and supplying power from the EVs'batteries (storage batteries) when a disaster or the like occurs and a power outage occurs at the facility. Moreover, conventionally, batteries (storage batteries) have been utilized as emergency power supplies when power interruption has occurred.

As disclosed in Patent Literature 1, an EV secures a discharge capacity required for a load device, calculates a dischargeable capacity of a backup battery, and discharges the backup battery by the calculated dischargeable capacity when an external power supply request is made.

### CITATION LIST

### Patent Literature

[Patent Literature 1] Japanese Unexamined Patent Publication No. 2020-96416

### SUMMARY OF INVENTION

### Technical Problem

When a plurality of EVs and a plurality of aid facilities are provided, a plurality of combinations of the EVs and the aid facilities are provided, a plurality of aid routes are also provided, and it is necessary to consider a combination that allows appropriate aid for the aid facilities. In the technology described in Patent Literature 1, it is not clear how such EVs provide an aid for such aid facilities.

In order to solve the above-described problem, an objective of the present invention is to provide an aid management device capable of efficiently aiding a facility by means of an aid vehicle.

### Solution to Problem

According to the present disclosure, there is provided an aid management device including: an aid vehicle information acquisition unit configured to acquire a storage location of an aid vehicle and the number of aid vehicles; an aid information acquisition unit configured to acquire a plurality of aid facility information items; a derivation unit configured to derive an aid pattern indicating a movement route for the aid vehicle to aid an aid facility on the basis of a location of the aid facility; and a notification unit configured to provide a notification of the aid pattern.

### Advantageous Effects of Invention

According to the present invention, it is possible to efficiently aid a facility by means of an aid vehicle.

### BRIEF DESCRIPTION OF DRAWINGS

FIG. 1 is a diagram showing an aid management system including an aid management server 100 in a first embodiment of the present disclosure.

FIG. 2 is a schematic diagram schematically showing a power supply aid plan.

FIG. 3 is a block diagram showing a functional configuration of the aid management server 100.

FIG. 4 is a flowchart showing an operation of the aid management server 100.

FIG. 5 is a flowchart showing a process of calculating a shortest movement route in an EV 200.

FIG. 6 is an explanatory diagram showing the decision of an aid facility 300, the decision of a movement route, and the allocation of the EV 200.

FIG. 7 is a block diagram showing a functional configuration of an aid management server 100a of the present disclosure.

FIG. 8 is a flowchart showing an operation of the aid management server 100a in a second embodiment.

FIG. 9 is a flowchart showing details of the processing of S106a.

FIG. 10 is a schematic diagram showing a movement time and a charging time.

FIG. 11 is a diagram showing an example of a hardware configuration of the aid management server 100 according to an embodiment of the present disclosure.

### DESCRIPTION OF EMBODIMENTS

Embodiments of the present disclosure will be described with reference to the accompanying drawings. If possible, the same parts are denoted by the same reference signs and redundant description thereof will be omitted.

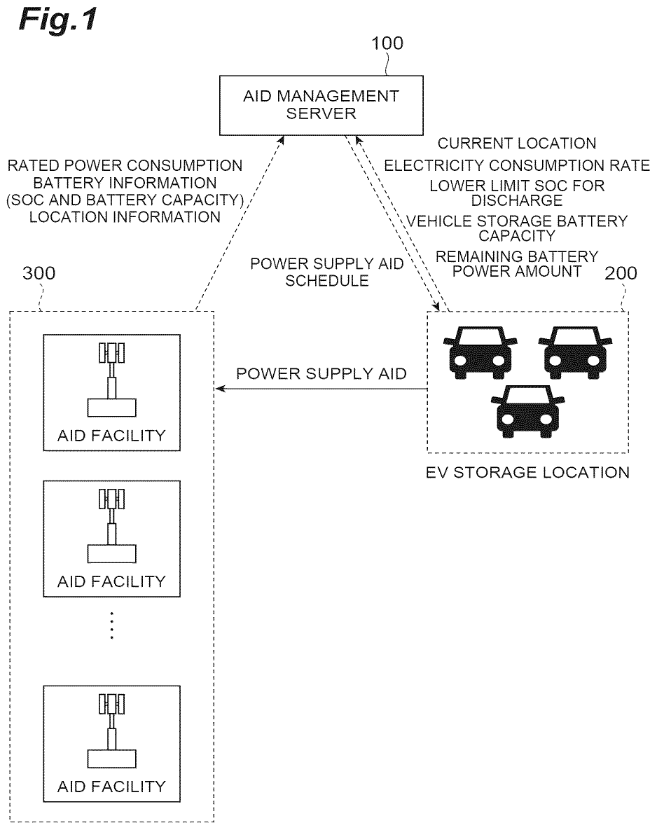

FIG. 1 shows an aid management system including an aid management server 100 in a first embodiment of the present disclosure. As shown in FIG. 1, the aid management server 100 manages an EV 200 in an EV storage location and controls an aid facility 300 to be aided. In the present disclosure, there are a plurality of EVs 200 and a plurality of aid facilities 300. The aid facility 300 is, for example, a base station constituting a mobile communication network.

The aid management server 100 acquires EV data including a current location (an EV storage location), an electricity consumption rate, a lower limit SOC for discharge, a vehicle storage battery capacity, and the remaining battery power amount from the EV 200 in the EV storage location. Moreover, the aid management server 100 acquires aid facility information including rated power consumption, battery information (the SOC and the battery capacity), and location information from the aid facility. Although an example of a single storage location is shown in FIG. 1, the present disclosure is not limited thereto. There may be a plurality of storage locations.

The aid management server 100 calculates the number of EVs 200 on the basis of the EV data and the aid facility information, divides the aid facilities 300 into several groups, and transmits a power supply aid schedule for each group to each EV 200. The power supply aid schedule includes relevant group information, an aid pattern (a movement route) in each group, and an EV 200 assigned to the group. A driver of the EV 200 looks at this power supply aid schedule and aids the aid facility 300 in accordance with an aid route.

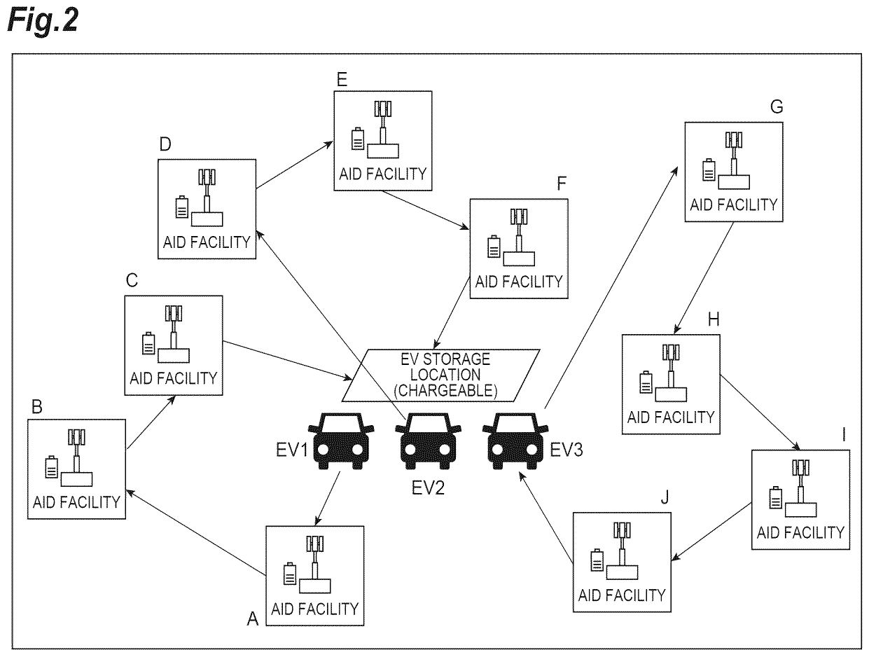

FIG. 2 is a schematic diagram of a power supply aid plan. As shown in FIG. 2, the schematic diagram shows the aid facility group, the aid pattern, and the EV 200 assigned to each group.

In FIG. 2, the aid management server 100 divides the aid facilities 300 into three groups, i.e., a group of aid facilities A, B, and C, a group of aid facilities D, E, and F, and a group of aid facilities G, H, I, and J. Also, an aid route is decided for each group. Subsequently, the aid management server 100 assigns the EV 200 to each aid pattern. In FIG. 2, EV1 is allocated to the group of aid facilities A, B, and C, EV2 is allocated to the aid facilities D, E, and F, and EV3 is allocated to the aid facilities G, H, I, and J. In FIG. 2, an aid pattern indicating a movement route of the EV 200 to aid the aid facilities is, for example, a movement route passing through aid facility A, aid facility B, and aid facility C in that order.

As shown in FIG. 2, there are three EVs 200 and ten aid facilities 300 and the aid management server 100 derives three aid patterns.

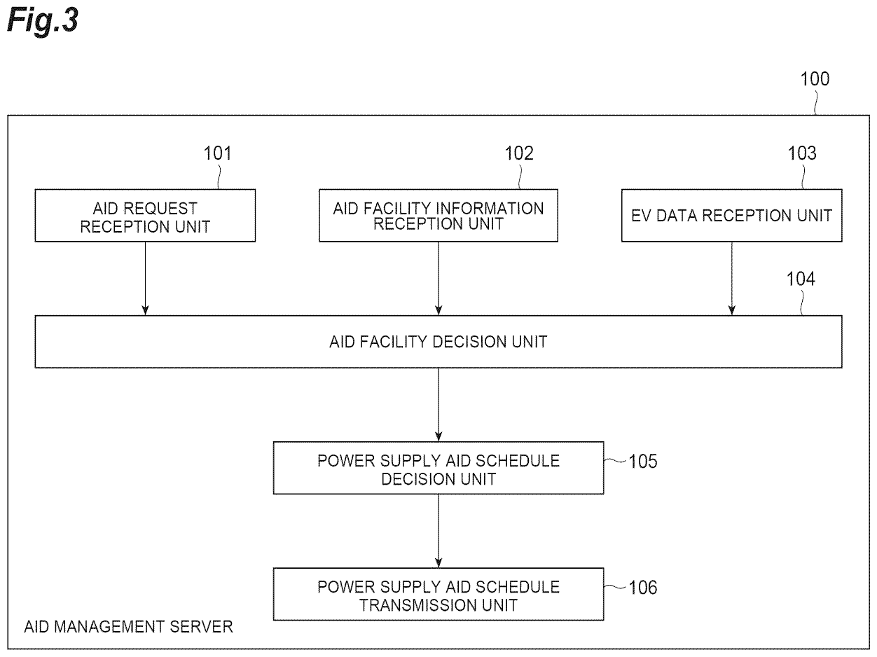

FIG. 3 is a block diagram showing a functional configuration of the aid management server 100. As shown in FIG. 3, the aid management server 100 is configured to include an aid request reception unit 101, an aid facility information reception unit 102, an EV data reception unit 103, an aid facility decision unit 104, a power supply aid schedule decision unit 105, and a power supply aid schedule transmission unit 106.

The aid request reception unit 101 is a part for receiving an aid request from one or more aid facilities 300.

The aid facility information reception unit 102 is a part for receiving aid facility information from one or more aid facilities 300. The aid facility information includes identification information, rated power consumption, battery information (an SOC and a battery capacity), and location information of each aid facility 300. In addition, information about priority of aid may be included. On the basis of this priority, some of the aid facilities 300 are selected. Also, when the aid is not available for all aid facilities 300, the aid facilities 300 that cannot be aided by the EV 200 are excluded.

The EV data reception unit 103 is a part for receiving EV data from each EV 200. The EV data includes identification information about the EV 200, a current location (a storage location), electricity consumption rate, a lower limit SOC for discharge, a vehicle storage battery capacity, and the remaining battery power amount.

The aid facility decision unit 104 is a part for acquiring an EV storage location, the number of EVs, a battery capacity of each EV, and the like from the EV data and the aid facility information, acquiring information (battery information and the like) for calculating the location and the amount of power required by the aid facility from the aid facility information, and deciding a group (a combination) of a plurality of aid facilities 300. The number of EVs is obtained by counting the identification information of the EV 200 included in the EV data.

The power supply aid schedule decision unit 105 decides a power supply aid schedule on the basis of the aid facilities 300 of the decided group, the aid facility information, and the EV data. The power supply aid schedule includes a group of aid facilities, an aid pattern (a movement route) in each group, and an EV 200 allocated for each group.

The power supply aid schedule transmission unit 106 transmits the power supply aid schedule to each EV 200. For example, a driver of each EV 200 owns a portable terminal, and a group (including the aid facility combination) allocated to the driver (the EV 200), the aid pattern, and identification information about the EV 200 for each aid pattern are transmitted to each portable terminal. In addition, the identification information about the EV 200 is not essential.

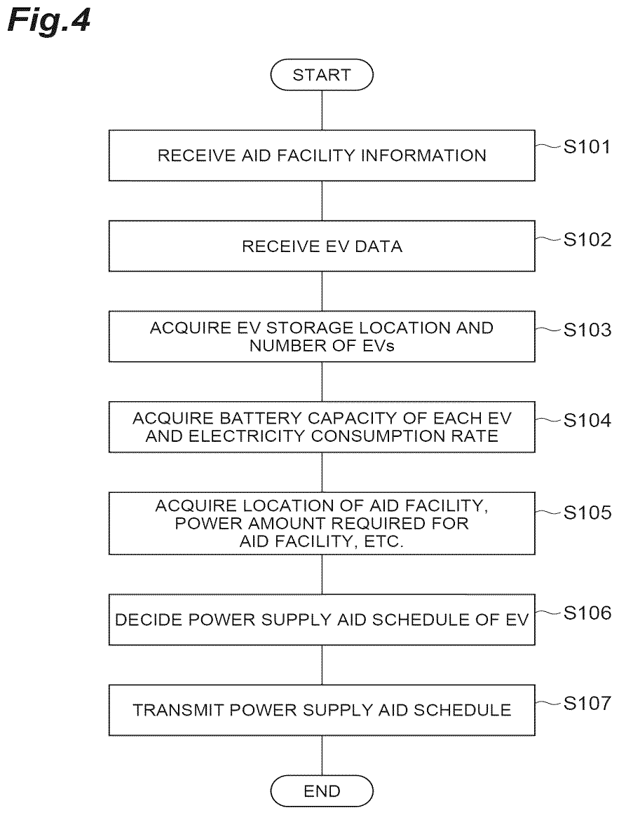

FIG. 4 is a flowchart showing the operation of the aid management server 100. When an aid request is received from each aid facility 300, the aid request reception unit 101 transmits a request for aid facility information to each aid facility 300 which has made the aid request and receives aid facility information transmitted in response to the request (S101). The EV data reception unit 103 receives EV data from each EV 200 (S102). The aid facility decision unit 104 acquires a storage location of each EV 200 and the number of EVs from the EV data (S103). Moreover, the aid facility decision unit 104 acquires a storage battery capacity of each EV 200, electricity consumption rate, a lower limit SOC for discharge, and the remaining battery power amount from the EV data (S104). Moreover, the aid facility decision unit 104 acquires rated power consumption of the aid facility 300 (S105).

The aid facility decision unit 104 decides an aid facility serving as an aid target and the power supply aid schedule decision unit 105 calculates a shortest movement route of the EV 200 to move around the aid facility 300 and decides a power supply aid schedule (S106).

The power supply aid schedule transmission unit 106 transmits the power supply aid schedule to each EV 200 (S107).

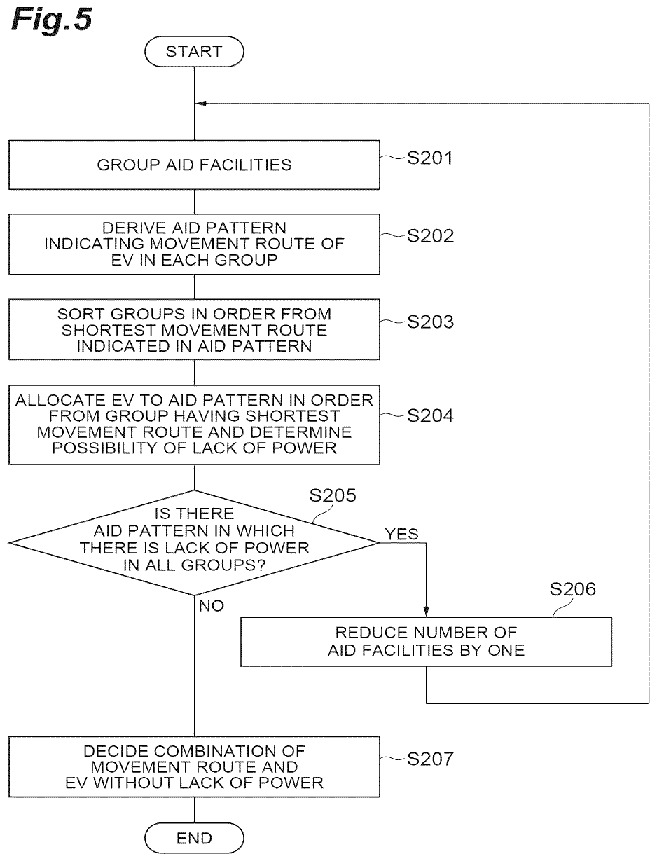

Next, the processing of S106 will be described. FIG. 5 is a flowchart showing a process of calculating a shortest movement route in the EV 200. The aid facility decision unit 104 derives which EV 200 will aid which aid facility 300, i.e., a group of aid facilities 300 serving as an aid target (S201). Also, the aid facility decision unit 104 derives an aid pattern indicating a movement route of the EV 200 in each group (S202). The aid facility decision unit 104 sorts the groups in order from the shortest movement route of the EV 200 (S203).

The aid facility decision unit 104 allocates an EV 200 in order from a group associated with the shortest movement route according to an aid pattern, and determines which of the EVs 200 runs out of power (S204). When it is determined that there is any EV 200 that runs out of power in all the groups (S205: YES), the aid facility decision unit 104 reduces the number of aid facilities 300 by one in accordance with a predetermined condition and groups the aid facilities 300 again (S206). For example, the number of aid facilities may be reduced on the basis of the priority, or the farthest aid facility can be excluded on the basis of a positional relationship. Moreover, priority may be given to an aid facility requiring excessive power, or conversely, such an aid facility may be excluded.

When it is determined that there is a group in which any EV 200 does not run out of power (S205: NO), the aid facility decision unit 104 decides a combination of the aid pattern of the group and the EV 200 and decides a power supply aid schedule (S207). When there are a plurality of groups that do not run out of power, any group may be decided, or an initially decided group may be adopted.

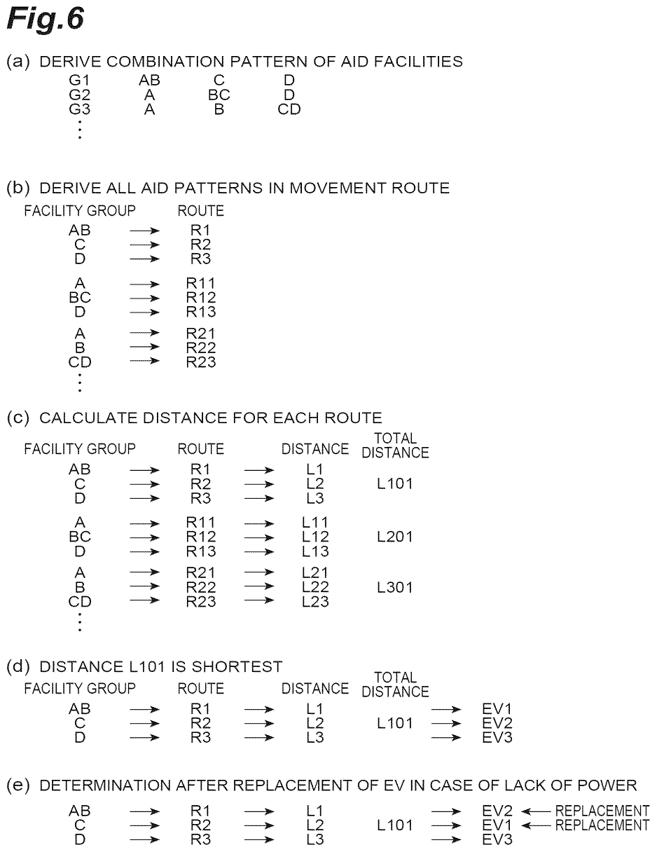

FIG. 6 is an explanatory diagram showing the decision of the aid facility 300, the decision of the movement route, and the allocation of the EV 200. Here, for convenience of description, it is assumed that there are aid facilities A, B, C, and D. FIG. 6(a) is a diagram showing the grouping of aid facilities 300. The aid facility decision unit 104 decides and groups combination patterns of aid facilities. For example, the aid facility decision unit 104 divides groups G1 to Gx as a combination pattern of the aid facilities 300.

FIG. 6(b) is a diagram showing an aid pattern (a movement route) derived for each combination (group) of aid facilities 300. The power supply aid schedule decision unit 105 derives a movement route passing through a plurality of aid facilities 300. For example, for a group of aid facility A and aid facility B, a route R1 passing through both of them is derived. The power supply aid schedule decision unit 105 also derives another movement route of aid facilities 300.

FIG. 6(c) shows a movement distance L obtained by calculating a total of routes R derived in FIG. 6(b) for each facility group. Here, a distance L101 is a value obtained by calculating a sum of distances L1 to L3 of routes R1 to R3. Here, the distance L101 is a shortest distance.

FIG. 6(d) shows that the EV 200 is allocated for each route R. For example, the power supply aid schedule decision unit 105 allocates EV1 to the route R1, allocates EV2 to the route R2, and allocates EV3 to the route R3. Here, the power supply aid schedule decision unit 105 determines a possibility that each EV 200 will run out of power.

For example, the power supply aid schedule decision unit 105 determines whether or not the EV 200 will run out of power on the way on the basis of a movement distance of the EV 200, a battery capacity of the EV 200, electricity consumption rate of the EV 200, and charge power from the EV 200 to the aid facility 300.

The power supply aid schedule decision unit 105 determines whether or not the EV 200 will run out of power on the way by determining whether or not an amount of power for aiding the aid facility 300 and an amount of power required for movement are larger than an amount of power accumulated in the battery of the EV 200.

The power supply aid schedule decision unit 105 divides the movement distance of the EV 200 by the electricity consumption rate thereof, thereby calculating an amount of movement power of the EV 200 during movement. Moreover, the power supply aid schedule decision unit 105 acquires SOCi and battery capacity Hi of the storage battery of the aid facility from the aid facility information. “Battery capacity Hi×F−SOCi×battery capacity Hi” is used as an amount of charge power. i denotes an aid facility. F denotes a charge rate and is set to any value. For example, the charge rate is set to 85%. Also, the power supply aid schedule decision unit 105 determines whether a lack-of-power determination condition in which the remaining amount of battery power stored in the battery of the EV 200 is greater than a sum of the amount of movement power of the EV 200 and the amount of charge power of the EV 200 is satisfied.

The power supply aid schedule decision unit 105 determines that there is no lack of power when the lack-of-power determination condition is satisfied (when the remaining amount of battery power stored in the battery of the EV 200 is greater than a sum of the amount of movement power of the EV 200 and the amount of charge power of the EV 200). On the other hand, when the lack-of-power determination condition is not satisfied, it is determined that the EV 200 will run out of power on the way, and the power supply aid schedule decision unit 105 replaces the movement route and the EV 200 and determines a possibility of a lack of power again as shown in FIG. 6(e).

When it is determined that there is a lack of power in all the patterns (S205: YES), the aid facility decision unit 104 excludes one aid facility on the basis of a predetermined priority or the like and derives a group of aid facilities again (S201).

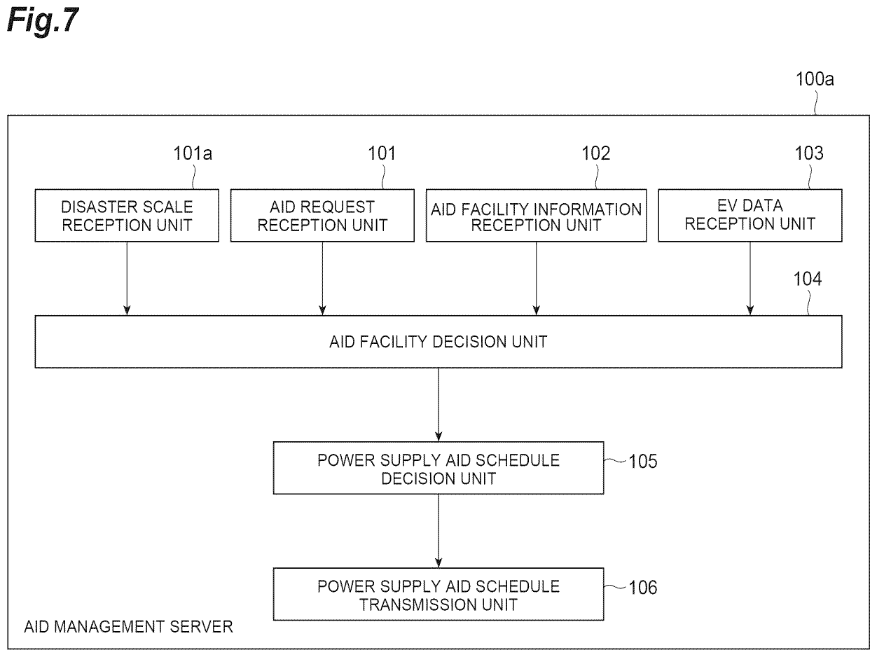

Next, a second embodiment will be described. In the second embodiment, a mechanism in which the EV 200 aids the aid facility 300 at least twice in accordance with a scale of a disaster is disclosed. FIG. 7 is a block diagram showing a functional configuration of an aid management server 100a of the present disclosure. Unlike the aid management server 100a in the first embodiment, the aid management server includes a disaster scale reception unit 101a.

The disaster scale reception unit 101a is a part for receiving a disaster scale issued by a national or prefectural government. In the national or prefectural government, there is a disaster scale management server and the disaster scale management server transmits a disaster scale to the aid management server 100a when a disaster occurs.

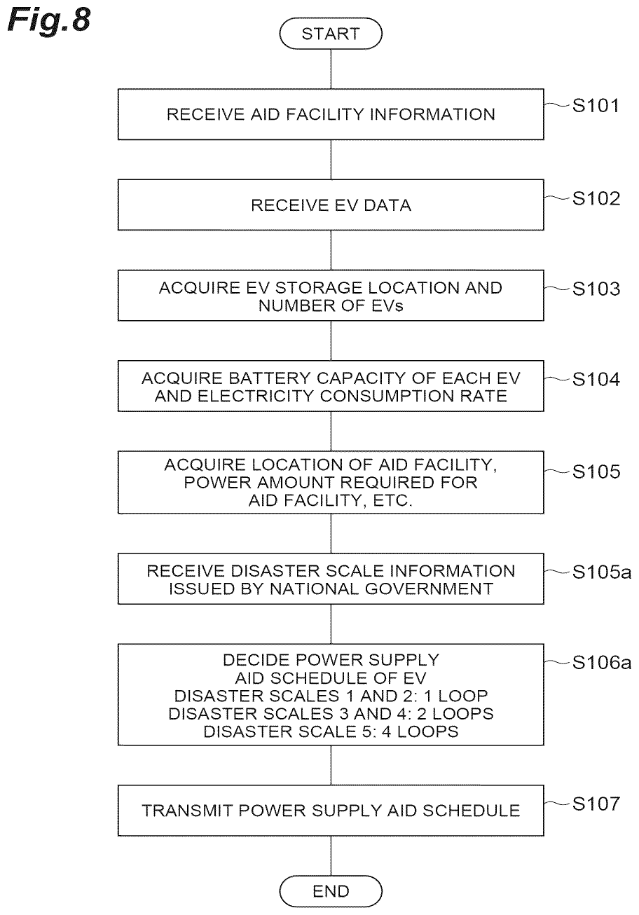

FIG. 8 is a flowchart showing an operation of the aid management server 100a of the second embodiment. The processing of S101 to S105 is the same as in the first embodiment (FIG. 4), and the aid management server 100a receives aid facility information, EV data, and the like. The disaster scale reception unit 101a receives disaster scale information (S105a). Also, the power supply aid schedule decision unit 105 determines a power supply aid schedule according to the disaster scale (S106a). The power supply aid schedule transmission unit 106 transmits the power supply aid schedule to the EV 200 (S106).

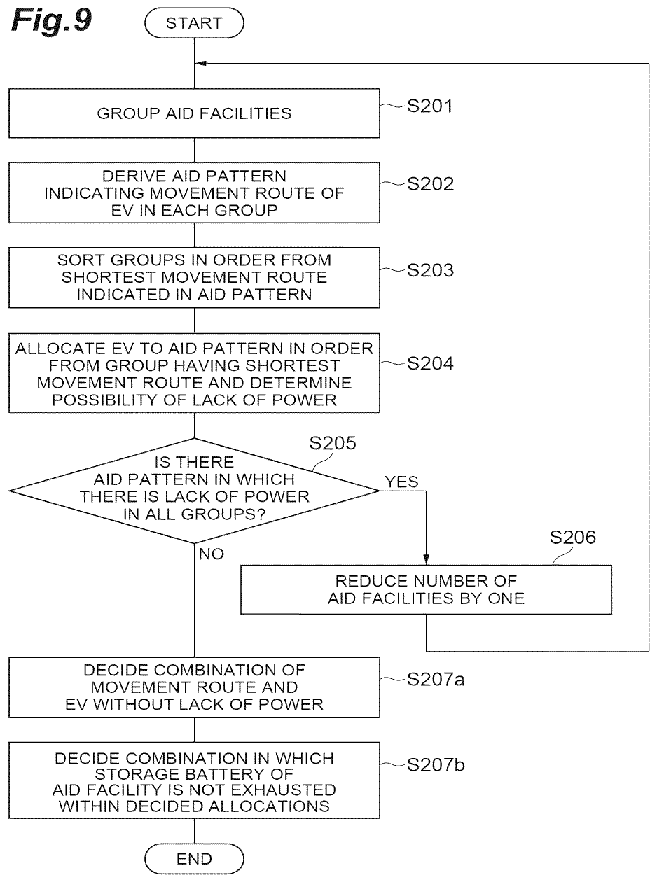

FIG. 9 shows details of the processing of S106a. Unlike the flowchart in FIG. 5, the processing of S207a and S207b is added. Any of the allocations of a plurality of movement routes and EVs 200 is decided in the processing of S207 of FIG. 5 in the first embodiment. However, here, the power supply aid schedule decision unit 105 decides a combination in which the storage battery of the aid facility 300 is not exhausted in a second loop (S207b) from among the decided combinations of the EVs 200 and the aid patterns (S207a). In addition, when there is no combination in which the storage battery of the aid facility 300 is not exhausted, the number of aid facilities may be reduced by one (S206). In this case, it is considered to exclude the aid facility whose storage battery is exhausted.

That is, the power supply aid schedule decision unit 105 determines whether or not the storage battery of the aid facility 300 will be exhausted during a period obtained by calculating a sum of the charging time for each aid facility 300, the moving time of the EV 200, and the charging time (for example, one hour) of the EV 200 for each group.

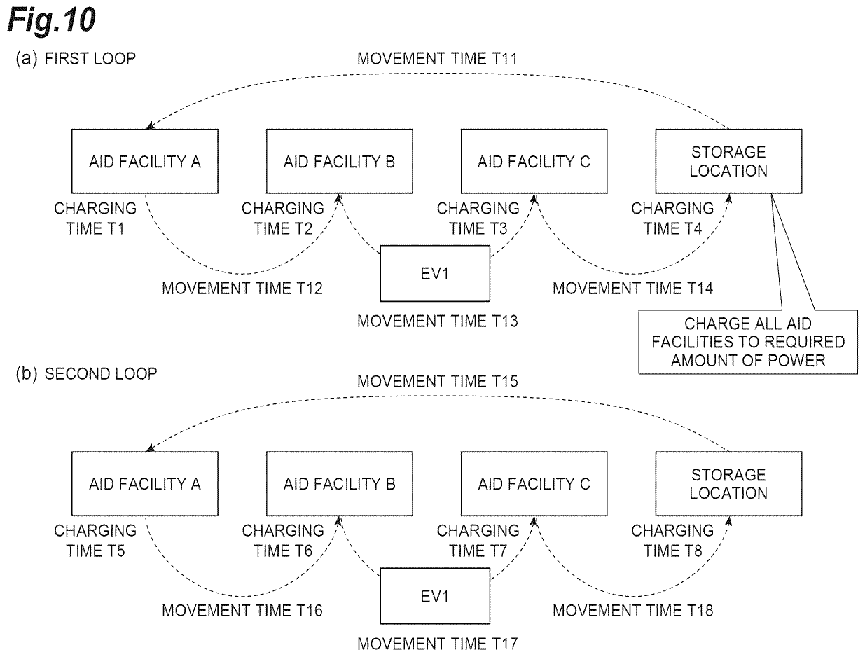

FIG. 10 is a schematic diagram showing the moving time and charging time of EV1. As shown in FIG. 10(a), EV1 moves while charging the aid facilities A to C. When EV1 returns to a storage location, time T10 obtained by calculating a sum of movement time T11 to T14 and time T0 obtained by calculating a sum of charging time T1 to T3 for charging each aid facility 300 are required. Furthermore, charging time T4 is required for charging EV1 in the storage location.

Also, the aid facility A determines whether or not a power outage has occurred during a period obtained by calculating a sum of the charging time T2, the charging time T3, the movement time T11 to T13, and the movement time T14 (see FIG. 10(b)). The determination is also made for other aid facilities B and C similarly. The determination of whether or not the power outage has occurred is made on the basis of the rated power consumption and the storage battery capacity of each aid facility. That is, the operating time based on the storage battery in the aid facility 300 is calculated from the rated power consumption and the remaining amount of the storage battery and whether the aid facility 300 is in operation is determined on the basis of the operating time and the time when the EV 200 returns to the aid facility 300.

In addition, the storage battery charge amount of the aid facility 300 is, for example, 85% of the total capacity of each storage battery, but may be a numerical value other than 85%. Moreover, in the storage location, the battery of the EV 200 is fully charged. In addition, to prevent a lack of power even in the second and subsequent loops, it is necessary to charge the battery of the EV 200 so that the battery power exceeds power based on the movement time, the charging time for each of the aid facilities, the charging time for the EV 200 in the storage location, and the rated power consumption for each of the aid facilities 300, and the charge amount for the aid facilities 300 with respect to the EV 200.

Next, the operations and effects of the aid management server 100 and the aid management server 100a functioning as the aid management device of the present disclosure will be described. The EV data reception unit 103 receives EV data from each EV 200, and the aid facility decision unit 104 (an aid vehicle information acquisition unit) acquires storage locations of the plurality of aid vehicles and the number of aid vehicles. Moreover, the aid facility information reception unit 102 receives aid facility information from each of the plurality of aid facilities 3200, and the aid facility decision unit 104 (an aid information acquisition unit) acquires the aid facility information. The power supply aid schedule decision unit 105 functions as a derivation unit for deriving an aid pattern and derives an aid pattern indicating a movement route for the EV 200 as the aid vehicle for aid facilities 300 on the basis of locations of the aid facilities 300. The power supply aid schedule transmission unit 106 (a notification unit) transmits the aid pattern to the driver of the EV 200.

With this configuration, aid patterns for a plurality of EVs 200 and a plurality of aid facilities can be obtained. In the present disclosure, the aid vehicle is an electric vehicle having a battery and the aid facility 300 is aided by receiving charge from the battery of the EV 200. In addition to the electric vehicle, the present invention can also be applied using a PHEV (plug-in hybrid) or HEV battery. In addition to the power-based supply, the present invention can also be applied to the aid based on fuel such as gasoline which is called energy.

In the disclosure, the aid pattern is defined so that at least one EV 200 may aid the aid facility 300.

The power supply aid schedule decision unit 105 classifies the number of EVs 200 (the number of aid vehicles) for aiding the plurality of aid facilities 300, derives a plurality of combinations of the aid facilities 300, and derives an aid pattern for each combination. Also, the power supply aid schedule decision unit 105 decides an aid pattern having a shortest movement route of all EVs 200 among a plurality of aid patterns determined for each combination of the aid facilities 300.

With this configuration, an aid pattern of shortened time can be decided, efficient aid can be performed, and the possibility that the operation of the aid facility 300 will be stopped is reduced.

Moreover, the power supply aid schedule decision unit 105 allocates an EV 200 to each of the plurality of movement routes of an aid pattern and reallocates an EV 200 in another aid pattern when the EV 200 allocated to the movement route is likely to stop on the way due to a lack of power or the like.

Moreover, the power supply aid schedule decision unit 105 excludes a predetermined aid facility based on the priority or the like from the plurality of aid facilities 300 when the EV 200 is not allocated to all the aid patterns. The priority is set in advance and included in the aid facility information.

Moreover, in the aid management server 100a in the second embodiment, the disaster scale reception unit 101a receives a scale of a disaster that has occurred during aid and the power supply aid schedule decision unit 105 decides an aid pattern on the basis of the disaster scale.

Thereby, an appropriate aid pattern can be decided on the basis of the disaster scale transmitted from the national government or the like.

Moreover, in the aid management server 100a, the power supply aid schedule decision unit 105 calculates the number of aid loops on the basis of the disaster scale.

Therefore, in case of a major disaster or the like, for example, because the spread of the aid facility 300 may be delayed, the EV 200 can be dispatched to the aid facility at least twice and the operation of the aid facility 300 can be maintained.

Moreover, in the aid management server 100a of the present disclosure, the power supply aid schedule decision unit 105 decides an aid pattern in which the operation of the aid facility 300 is not stopped. A state in which the operation of the aid facility is not stopped is, for example, a state in which the aid facility 300 is in operation until the EV 200 returns to the same aid facility 300 again.

Thereby, a state in which the aid based on the EV 200 cannot be made in time is eliminated.

The aid management device of the present disclosure has the following configuration.
[1]

An aid management device comprising:
an aid vehicle information acquisition unit configured to acquire a storage location of an aid vehicle and the number of aid vehicles;
an aid information acquisition unit configured to acquire a plurality of aid facility information items;
a derivation unit configured to derive an aid pattern indicating a movement route for the aid vehicle to aid an aid facility on the basis of a location of the aid facility; and
a notification unit configured to notify the aid pattern.
[2]

The aid management device according to [1],
wherein the aid vehicle is an electric vehicle having a battery, and
wherein the aid facility received an aid by receiving charge power from the battery of the aid vehicle.
[3]

The aid management device according to [1] or [2], wherein the aid pattern is determined so that at least one aid vehicle provides an aid to an aid facility.
[4]

The aid management device according to any one of [1] to [3], wherein the derivation unit
derives a plurality of aid facility combinations by classifying the number of aid vehicles for aiding the plurality of aid facilities and derives an aid pattern for each combination, and
decides an aid pattern in which a movement route of all aid vehicles is shortest among a plurality of aid patterns determined for each aid facility combination.
[5]

The aid management device according to [4], wherein the derivation unit
allocates an aid vehicle to each of a plurality of movement routes of the aid pattern, and
reallocates the aid vehicle in another aid pattern when there is a possibility that the aid vehicle allocated to the movement route will stop on the way.
[6]

The aid management device according to [5], wherein the derivation unit excludes a predetermined aid facility from the plurality of aid facilities when the aid vehicles are not allocated to all aid patterns.
[7]

The aid management device according to any one of [1] to [6], further comprising a reception unit configured to receive a scale of a disaster that has occurred at the time of aid,
wherein the derivation unit decides an aid pattern on the basis of the disaster scale.
[8]

The aid management device according to [7], wherein the derivation unit calculates the number of aid loops on the basis of the disaster scale.
[9]

The aid management device according to [8], wherein the derivation unit decides an aid pattern for preventing an operation of the aid facility from being stopped.
[10]

The aid management device according to [9], wherein a state in which the operation of the aid facility is not stopped is a state in which the aid facility is in operation until the aid vehicle returns to the same aid facility again.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

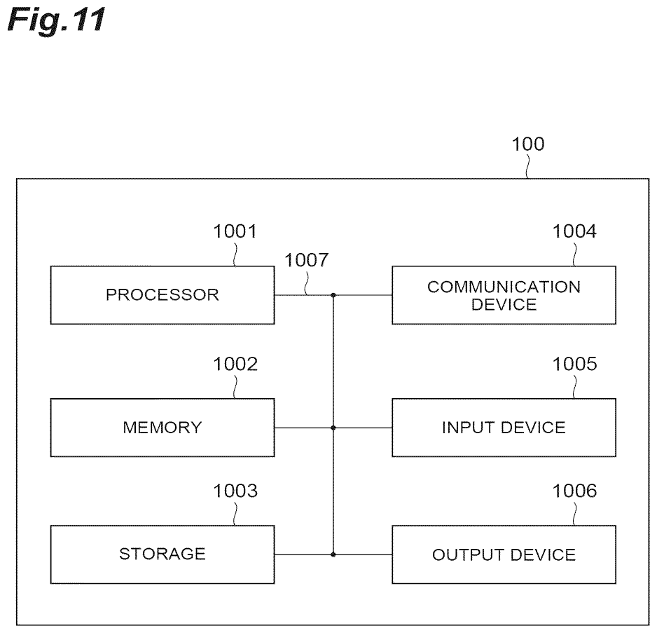

For example, the aid management server 100 and the aid management server 100a (hereinafter referred to as the aid management server 100 unless otherwise specified) according to one embodiment of the present disclosure may function as a computer that performs processing of a aid management method or a conversation information generation method according to the present disclosure. FIG. 11 is a view showing an example of the hardware configuration of the aid management server 100 according to one embodiment of the present disclosure. The aid management server 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the aid management server 100 may be configured to include one or a plurality of the devices shown in the drawings or may be configured without including some of those devices.

The functions of the aid management server 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the aid facility decision unit 104, the power supply aid schedule decision unit 105 described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, the aid facility decision unit 104, the power supply aid schedule decision unit 105 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing the aid management method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described conversation unit 101 or the like may be implemented by the communication device 1004. The aid request reception unit 101, an aid facility information reception unit 102, an EV data reception unit 103, a power supply aid schedule decision unit 105, and the disaster scale reception unit 101a may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the aid management server 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 Aid management server
100a Aid management server
101 Aid request reception unit
101a Disaster scale reception unit
102 Aid facility information reception unit
103 EV data reception unit
104 Aid facility decision unit
105 Power supply aid schedule decision unit
106 Power supply aid schedule transmission unit

1. An aid management device comprising:
an aid vehicle information acquisition unit configured to acquire a storage location of an aid vehicle and the number of aid vehicles;
an aid information acquisition unit configured to acquire a plurality of aid facility information items;
a derivation unit configured to derive an aid pattern indicating a movement route for the aid vehicle to aid an aid facility on the basis of a location of the aid facility; and
a notification unit configured to notify the aid pattern.

2. The aid management device according to claim 1,
wherein the aid vehicle is an electric vehicle having a battery, and
wherein the aid facility received an aid by receiving charge power from the battery of the aid vehicle.

3. The aid management device according to claim 1, wherein the aid pattern is determined so that at least one aid vehicle provides an aid to an aid facility.

4. The aid management device according to claim 1, wherein the derivation unit
derives a plurality of aid facility combinations by classifying the number of aid vehicles for aiding the plurality of aid facilities and derives an aid pattern for each combination, and
decides an aid pattern in which a movement route of all aid vehicles is shortest among a plurality of aid patterns determined for each aid facility combination.

5. The aid management device according to claim 4, wherein the derivation unit
allocates an aid vehicle to each of a plurality of movement routes of the aid pattern, and
reallocates the aid vehicle in another aid pattern when there is a possibility that the aid vehicle allocated to the movement route will stop on the way.

6. The aid management device according to claim 5, wherein the derivation unit excludes a predetermined aid facility from the plurality of aid facilities when the aid vehicles are not allocated to all aid patterns.

7. The aid management device according to claim 1, further comprising a reception unit configured to receive a scale of a disaster that has occurred at the time of aid,
wherein the derivation unit decides an aid pattern on the basis of the disaster scale.

8. The aid management device according to claim 7, wherein the derivation unit calculates the number of aid loops on the basis of the disaster scale.

9. The aid management device according to claim 8, wherein the derivation unit decides an aid pattern for preventing an operation of the aid facility from being stopped.

10. The aid management device according to claim 9, wherein a state in which the operation of the aid facility is not stopped is a state in which the aid facility is in operation until the aid vehicle returns to the same aid facility again.
